(19) United States
(12) Patent Application Publication
(10) Pub. No.: US 2026/0139720 A1
(43) Pub. Date: May 21, 2026

(54) PROTRUSION-TYPE IMPACT ABSORBING MEMBER

(71) Applicant: WON JUN KIM, Incheon (KR)

(72) Inventor: WON JUN KIM, Incheon (KR)

(21) Appl. No.: 19/229,538

(22) Filed: Jun. 5, 2025

(30) Foreign Application Priority Data
Nov. 19, 2024 (KR) 10-2024-0164791

(51) Int. Cl. F16F 7/12

(52) U.S. Cl. CPC F16F 7/12; F16F 2224/0233

(57) ABSTRACT

A step is formed to partition an impact absorbing protrusion into at least two sub-protrusions, and when an impact is applied, some of the sub-protrusions and the step are destroyed sequentially in order from the most vulnerable to the impact, and thus the impact can be absorbed over a wide impact absorbing range. In particular, as the sub-protrusions and the step are manufactured with different thicknesses and lengths, a damage order of the sub-protrusions and the step is predetermined in a manufacturing process, the sub-protrusions and the step are destroyed in the predetermined order, and thus an impact absorbing effect can be stably obtained.

### CROSS-REFERENCE TO RELATED APPLICATION

This application claims priority to and the benefit of Korean Patent Application No. 10-2024-0164791 filed on Nov. 19, 2024, the disclosure of which is incorporated herein by reference in its entirety.

### BACKGROUND

### 1. Field of the Invention

The present invention relates to a protrusion-type impact absorbing member, and more particularly, to a protrusion-type impact absorbing member in which, when a plurality of impact absorbing protrusions are integrally formed on a base by injection molding, at least one step is formed on each impact absorbing protrusion and partitioned into at least two sub-protrusions, at least one of a thickness, a width, and a length of each sub-protrusion and the step is formed differently, and thus a weak impact is absorbed, and even when a strong impact is applied, a relatively weak portion is first destroyed, and an impact may be absorbed over a wide range. In this case, four adjacent impact absorbing protrusions among the impact absorbing protrusions are arranged on the base in various shapes such as a rectangle, a square, and a rhombus, and thus an impact may be smoothly absorbed. Further, the impact absorbing protrusions are manufactured in different sizes, and when another member is placed on the impact absorbing protrusions, the impact absorbing protrusions having the different sizes are manufactured according to a height difference from this member, and thus an impact may be stably absorbed even for a wide range of impacts.

### 2. Discussion of Related Art

In general, a technology related to an impact absorbing member that is destroyed by an impact when an external impact is applied, and thus absorbs the impact like a free motion headform (FMH) mounted on a head liner installed inside a vehicle to face a roof panel in the vehicle is disclosed in Patent Document 1 below.

(Patent Document 1) Korean Patent No. 10-0948458

A modular energy absorber is tunable. The modular energy absorber includes one or more energy absorbing modules. The energy absorbing module includes a means for integrating energy absorbing units of one or more modules. The means for integration positions and supports the units in relation to each other before, during, and after a relative motion between an accident target and an energy absorber. An impactable member is provided to have an upper boundary portion, a lower boundary portion, and an intermediate wall extending therebetween. This member also has multiple opening holes therein before an impact. A method of forming the modular energy absorber is also provided.

### Related Art Documents

### Patent Documents

(Patent Document 1) Korean Patent No. 10-0948458 (Registration Date: Mar. 11, 2010)

### SUMMARY OF THE INVENTION

However, the existing impact absorbing member manufactured in the form of a protrusion has the following problems.
(1) The existing impact absorbing member is molded by a press molding method and thus can only be manufactured with a certain thickness.
(2) In this case, when an external impact is applied to a protrusion that is a portion at which an impact is substantially absorbed, as this protrusion is damaged or deformed to absorb the impact, when the impact deviates from a set intensity range, an impact absorbing effect is degraded or the impact is not absorbed, and thus the impact may directly be transmitted to a driver or the like and cause injury.
(3) For example, when the impact absorbing member is manufactured to be damaged when an external force of 10 N is applied to the protrusion, even when a smaller impact, e.g., an external force of 3 N to 8 N, is applied to the protrusion, the impact is hardly absorbed through the protrusion. That is, with the existing impact absorbing member, only when the impact is in a range of about 9 N to 11 N, is the protrusion damaged and the impact absorbed, and thus an impact absorbing range is narrow.
(4) Meanwhile, in this way, when the impact absorbing member is molded by press processing, the protrusion may only be molded with a constant thickness due to characteristics of press processing. This may allow an impact absorbing effect to be obtained with the existing impact absorbing member only when an external impact is applied to the extent that the protrusion is destroyed and an absorbed external impact range cannot be expanded.

The present invention is directed to providing a protrusion-type impact absorbing member in which, when a plurality of impact absorbing protrusions manufactured in the form of a protrusion are integrally injection-molded in a base, the impact absorbing protrusion is molded to be partitioned into at least two sub-protrusions through at least one step, a strong impact is absorbed as the plurality of sub-protrusions and the step are destroyed sequentially in order from the most vulnerable to the impact even when the strong impact is applied, and thus the impact absorbing member may be more safely used over a wide impact absorbing range.

The present invention is also directed to providing a protrusion-type impact absorbing member in which at least one of thicknesses of the sub-protrusions and the step and at least one of lengths thereof have different dimensions, a damage order of the sub-protrusions and the step is predetermined in a manufacturing process, the sub-protrusions and the step are destroyed in the predetermined order, and thus an impact absorbing effect may be stably obtained.

The present invention is also directed to providing a protrusion-type impact absorbing member in which, as the impact absorbing protrusions are arranged differently, sizes thereof are changed, or plates are placed on the impact absorbing protrusions, the impact absorbing protrusions are manufactured at different heights depending on a gap therebetween, the sub-protrusions and the step are sequentially damaged due to an external impact applied to the impact absorbing protrusions according to a use purpose at a mounting position, and thus the impact can be stably absorbed.

A protrusion-type impact absorbing member is manufactured by injection-molding a synthetic resin such that a plurality of impact absorbing protrusions (110) integrally protrude from a surface of a base (100), wherein each of the impact absorbing protrusions (110) is formed to narrow toward an outside from the base (100) and has at least one step (111) so that the protruding portion is partitioned into at least two sub-protrusions (110', 110''), at least one of thicknesses (a, b) of the sub-protrusions (110′, 110″) and a thickness (c) of the step (111) is formed to be different, and at least one of lengths (d, e) of the sub-protrusions (110′, 110″) and a width (f) of the step (111) is formed to be different.

Four adjacent impact absorbing protrusions (110) among the impact absorbing protrusions (110) may be arranged on the base (100) in at least one shape of a square, a rectangle, a rhombus, and a trapezoid.

At least one of the impact absorbing protrusions (110) may have a different size. The impact absorbing protrusions (110) are formed in different sizes according to heights between member surfaces placed on the impact absorbing protrusions (110) and the surface of the base (100).

The impact absorbing member may be manufactured by injection-molding polypropylene (PP), polyethylene (PE), ethylene vinyl acetate (EVA), thermoplastic polyurethane (TPU), polycarbonate (PC), or high-density polyethylene (HDPE).

### BRIEF DESCRIPTION OF THE DRAWINGS

The above matters and other objects, features and advantages of the present disclosure will become more apparent to those of ordinary skill in the art by describing exemplary embodiments thereof in detail with reference to the accompanying drawings, in which:

A set of FIG. 1A and FIG. 1B is a view illustrating a protrusion-type impact absorbing member according to the present invention, wherein FIG. 1A is a perspective view and FIG. 1B is a front view;

FIG. 2 is a plan view illustrating a protrusion-type impact absorbing member according to the present invention;

FIG. 3 is a cross-sectional view along line “A-A” in FIG. 2 illustrating a configuration of the impact absorbing protrusion according to the present invention;

A set of FIG. 4A and FIG. 4B is a view illustrating an example in which the impact absorbing protrusion according to the present invention is disposed differently, wherein FIG. 4A is a plan view and FIG. 4B is a front view; and

FIG. 5 is a front view illustrating an example in which portions of the impact absorbing protrusion are manufactured in different sizes according to the present invention.

### DETAILED DESCRIPTION OF EXEMPLARY EMBODIMENTS

Embodiments of the present invention will be described in more detail below with reference to the accompanying drawings. Prior to this, terms or words used in the specification and the appended claims should not be interpreted as being limited to usual or dictionary meanings and should be interpreted with meanings and concepts corresponding to the technical spirit of the present invention according to the principle that the inventor may properly define the concepts of the terms in order to describe his/her own disclosure in the best way.

Thus, the embodiments described in the specification and the configurations illustrated in the drawings are only embodiments of the present invention and do not represent the full technical spirit of the present invention. Accordingly, it should be understood that there may be various equivalents and modifications that can be substituted at the time of filing of this application.

### Configuration of Protrusion-type Impact Absorbing Member

As illustrated in FIGS. 1A to 5, a protrusion-type impact absorbing member according to the present invention includes a base 100 made of a synthetic resin and a plurality of impact absorbing protrusions 110 formed to protrude by being integrally injection-molded on a surface of the base 100.

In particular, each of the impact absorbing protrusions 110 is manufactured in a shape that narrows from the surface of the base 100 toward the outside and is partitioned into at least two sub-protrusions 110′ and 110″ as at least one step 111 is formed. Thus, when an external impact is applied, the components are destroyed sequentially in order from the most vulnerable to the impact, the impact is absorbed, and thus an impact absorbing range may be expanded.

In this case, at least one of thicknesses a and b of the sub-protrusions 110′ and 110″, a thickness c of the step 111, lengths d and e of the sub-protrusion 110′ and 110″, and a width f of the step 111 is manufactured differently, and thus these may be selectively manufactured in a manufacturing process so that, when an external impact is applied to the impact absorbing protrusion 110, any one of the sub-protrusions 110′ and 110″ and the step 111 is first destroyed, and the impact is sequentially absorbed.

Further, the impact absorbing protrusions 110 are arranged in various patterns, for example, four adjacent impact absorbing protrusions 110 among the impact absorbing protrusions 110 are arranged on the base 100 in at least one shape of a square, a rectangle, a rhombus, and a trapezoid, so that the protrusion-type impact absorbing member according to the present invention may obtain a partially constant impact absorbing effect or a partially different impact absorbing effect.

Here, as a size of at least one of the impact absorbing protrusions 110 is formed to be reduced, an impact absorbing effect may be increased as much as the reduced size. Further, when another member is placed on the impact absorbing protrusion 110, the impact absorbing protrusion 110 may be manufactured according to a distance between another member and the base 100 and used.

Finally, the protrusion-type impact absorbing member according to the present invention may be manufactured by injection-molding polypropylene (PP), polyethylene (PE), ethylene vinyl acetate (EVA), thermoplastic polyurethane (TPU), polycarbonate (PC), or high-density polyethylene (HDPE). Thus, the impact absorbing protrusions 110 having complex shapes and various lengths and thicknesses may be easily manufactured and may be easily separated and conveniently used in a mold after the molding.

Hereinafter, this configuration will be described in more detail with reference to the accompanying drawings.

### A. Base

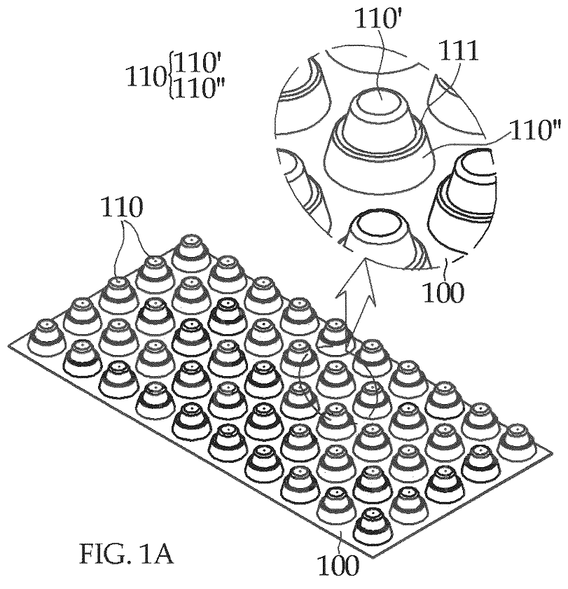

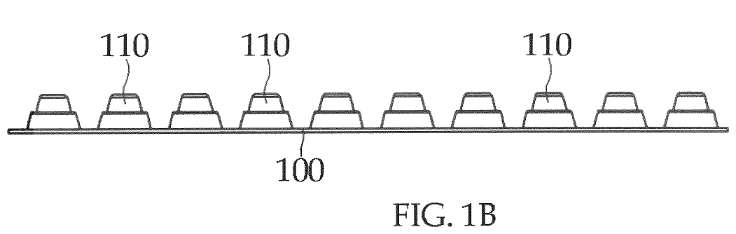

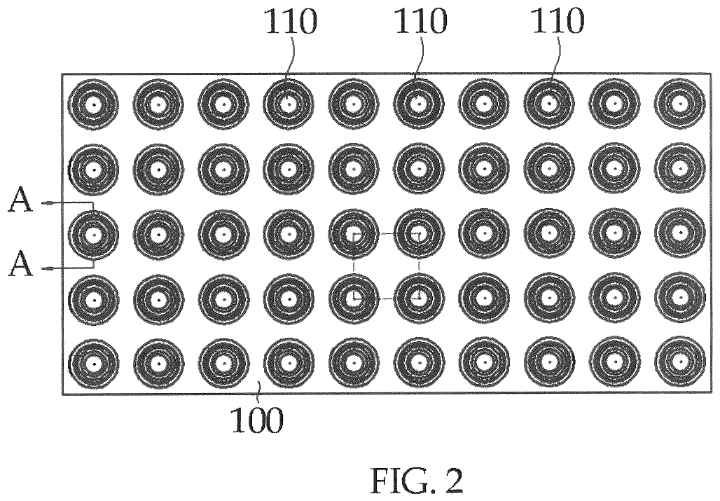

As illustrated in FIGS. 1A, 1B and 2, the base 100 serves to support the shape of the impact absorbing protrusion 110 as the impact absorbing protrusion 110, which will be described below, integrally protrudes and is molded from one surface. In this case, the base 100 may be manufactured in various sizes and shapes according to a position at which the protrusion-type impact absorbing member according to the present invention is mounted, and in particular, may be manufactured in a thickness that allows the base 100 to easily come into contact with and be mounted on a portion having a complex three-dimensional shape when the base 100 is mounted on a surface of a headliner of a vehicle. In the drawing, it is illustrated that the base 100 is manufactured in the shape of a rectangular plane.

As illustrated in FIGS. 1A to 3, the plurality of impact absorbing protrusions 110 integrally protrude from one surface of the base 100 formed in this way. In this case, as the base 100 and the impact absorbing protrusions 110 are manufactured by injection-molding a synthetic resin, the impact absorbing protrusions 110 having complex shapes and various thicknesses may be easily and integrally injection-molded. Further, examples of synthetic resins used in such injection molding may include polypropylene (PP), polyethylene (PE), ethylene vinyl acetate (EVA), thermoplastic polyurethane (TPU), polycarbonate (PC), and high-density polyethylene (HDPE).

### B. Impact Absorbing Protrusion

As illustrated in FIGS. 1A to 3, the plurality of impact absorbing protrusions 110 are formed to protrude from the surface of the base 100. Here, the impact absorbing protrusions 110 may be manufactured in a form in which an interval between two adjacent ones or the number of ones positioned therebetween is predetermined or may be manufactured in a different number and a different interval and used.

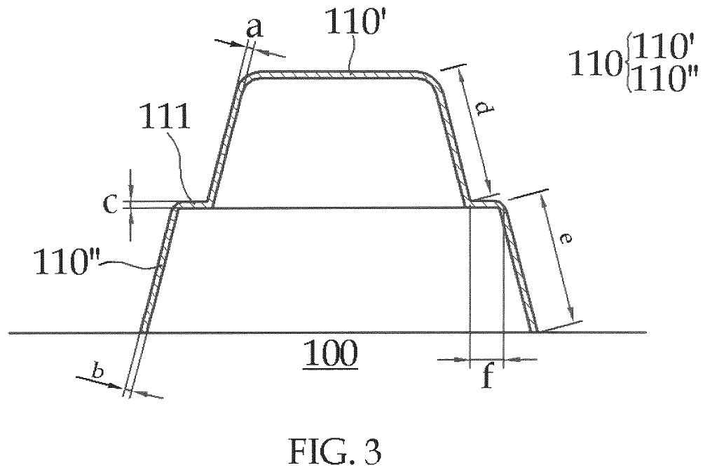

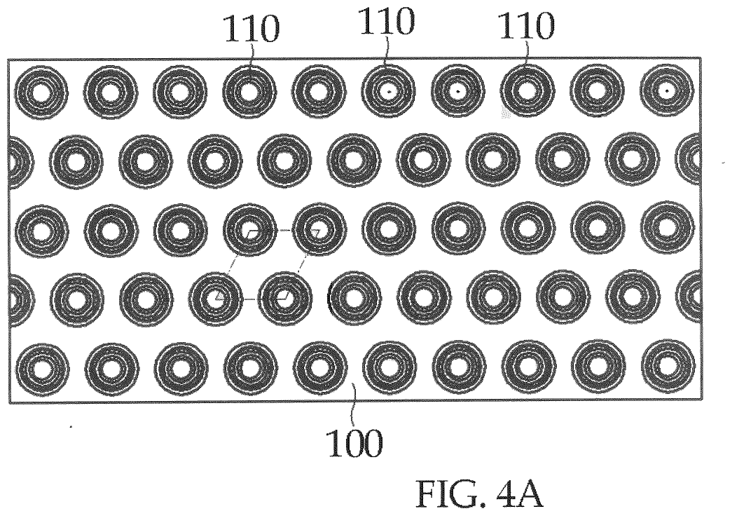

In this case, as illustrated in FIGS. 1A, 1B and 3, the at least one step 111 is formed in the impact absorbing protrusion 110, and thus a portion protruding from the impact absorbing protrusion 110 formed to protrude outward from the base 100 is partitioned into at least two sub-protrusions 110′ and 110″. When an external impact is applied to a portion protruding outward from the impact absorbing protrusion 110, portions of the outermost sub-protrusion 110′, the sub-protrusion 110″ attached to the base 100, and the step 111 positioned between these sub-protrusions 110′ and 110″ may be damaged sequentially in order from the most vulnerable to an impact, the external impact may be sequentially absorbed, and thus an impact absorbing range may be increased.

Here, in embodiments of the present invention, as illustrated in FIG. 3, in the impact absorbing protrusions 110, at least one of the thicknesses a and b of the sub-protrusions 110′ and 110″ and the thickness c of the step 111 is formed to be different, and at least one of the lengths d and e of the sub-protrusions 110′ and 110″ and the width f of the step 111 is manufactured to be different. Thus, when an impact is applied to the sub-protrusions 110′ and 110″ and the step 111, which one is damaged first and which ones are sequentially damaged may be variously selected in a design stage, and thus the impact absorbing protrusions 110 may be manufactured in a variety of ways.

Further, when the impact absorbing protrusions 110 according to the present invention are formed to integrally protrude from the surface of the base 100, the impact absorbing protrusions 110 may be arranged in various shapes or manufactured in different sizes to improve an impact absorbing effect, or may be manufactured with a varying intensity of the impact partially absorbed in the base 100.

For example, as in FIG. 2, four impact absorbing protrusions 110 may be formed integrally with the base 100 such that the four impact absorbing protrusions 110 are arranged in a square shape or a rectangular shape, or as in FIGS. 4A and 4B, the four impact absorbing protrusions 110 may be variously arranged and manufactured in a rhombus, a trapezoidal shape, or the like. Different impact absorbing performance may be achieved when an impact is simultaneously applied to the plurality of impact absorbing protrusions 110 as the number of impact absorbing protrusions 110 arranged in the base 100 may be changed with respect to an area of the base 100 having the same size, an arrangement interval therebetween may be changed, or arrangement positions thereof may be changed.

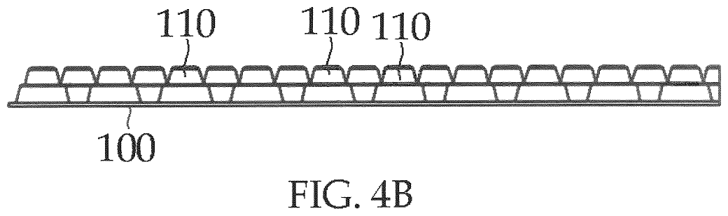

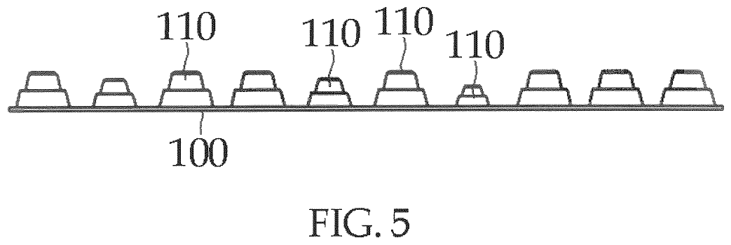

Further, as in FIG. 5, as at least one of the plurality of impact absorbing protrusions 110 is manufactured to have a smaller size than the other impact absorbing protrusions 110, an intensity of the impact that may be absorbed by the impact absorbing protrusion 110 having a small size may be changed, and thus it may be manufactured to have a different intensity of the impact that may be absorbed at a desired portion.

This makes it possible to usefully increase an impact absorbing range as the impact absorbing protrusions 110 are manufactured in different sizes according to different heights when an interval between the head liner and the loop panel is not constant like a free motion headform (FMH) used when the protrusion-type impact absorbing member according to the present invention is mounted on the head liner of a vehicle to protect the heads of a driver and a passenger.

According to the present invention, when an impact is applied to the impact absorbing protrusion, in the case of a weak impact, the weak impact may be absorbed by damage to the sub-protrusion and the step, and when a strong impact is applied, the at least two sub-protrusions and the step are destroyed sequentially in order from the most vulnerable to the impact to absorb the impact. Thus, an impact absorbing effect over a wide range may be obtained.

A protrusion-type impact absorbing member according to the present invention has the following effects.
(1) At least one step and at least two sub-protrusions are formed on each impact absorbing protrusion that is integrally injection-molded on one surface of a base, and thus when an external impact is applied, the step and the sub-protrusions are destroyed sequentially in order from the most vulnerable to the impact, and the impact can be absorbed.
(2) This allows the impact to be absorbed even when the external impact is weak or a relatively strong external impact is applied to the impact absorbing protrusion, so that a wide impact absorbing range can be set.

Thus, in the case of not only general passengers but also passengers having weak bodies such as the elderly and the children, the impact can be easily absorbed, and thus safety can be promoted.
(3) Meanwhile, as the sub-protrusions and the step can be manufactured to have different thicknesses, widths, and lengths, the amount of impact at which the sub-protrusions and the step are destroyed can be set differently, and thus the protrusion-type impact absorbing member according to the present invention can be set, manufactured, and used in a desired impact absorbing range according to a position and purpose of use thereof.
(4) Further, four adjacent impact absorbing protrusions among the impact absorbing protrusions can be arranged, manufactured and used in various shapes such as a rectangle, a square, and a rhombus, and thus can be manufactured by setting an impact range that can be absorbed for each area wider or narrower.
(5) In addition, as at least one of the plurality of impact absorbing protrusions is formed in a small size, an impact absorbing intensity can be set differently, and when another member is positioned on the impact absorbing protrusion, the impact absorbing protrusion can be manufactured in a different size according to a gap between a member surface and a base surface and used.
(6) This impact absorbing member is manufactured by injection-molding polypropylene (PP), polyethylene (PE), ethylene vinyl acetate (EVA), thermoplastic polyurethane (TPU), polycarbonate (PC), or high-density polyethylene (HDPE) and thus can be easily manufactured in a shape capable of adjusting an impact absorbing range of a thickness and a length thereof and used.
(7) The impact absorbing member according to the present invention can be installed wherever the impact is required to be absorbed when the impact absorbing member is used as a free motion headform (FMH) that is mounted on a headliner of a vehicle and used to protect the heads of a driver and a passenger or used as a member that is installed under an interior floor of a building and absorbs an impact.

What is claimed is:

1. A protrusion-type impact absorbing member which is manufactured by injection-molding a synthetic resin such that a plurality of impact absorbing protrusions (110) integrally protrude from a surface of a base (100),
wherein each of the impact absorbing protrusions (110) is formed to narrow toward an outside from the base (100) and has at least one step (111) so that the protruding portion is partitioned into at least two sub-protrusions (110′, 110″),
at least one of thicknesses (a, b) of the sub-protrusions (110′, 110″) and a thickness (c) of the step (111) is formed to be different, and
at least one of lengths (d, e) of the sub-protrusions (110′, 110″) and a width (f) of the step (111) is formed to be different.

2. The protrusion-type impact absorbing member of claim 1, wherein four adjacent impact absorbing protrusions (110) among the impact absorbing protrusions (110) are arranged on the base (100) in at least one shape of a square, a rectangle, a rhombus, and a trapezoid.

3. The protrusion-type impact absorbing member of claim 1, wherein at least one of the impact absorbing protrusions (110) has a different size.

4. The protrusion-type impact absorbing member of claim 3, wherein the impact absorbing protrusions (110) are formed in different sizes according to heights between member surfaces placed on the impact absorbing protrusions (110) and the surface of the base (100).

5. The protrusion-type impact absorbing member of claim 1, wherein the impact absorbing member is manufactured by injection-molding polypropylene (PP), polyethylene (PE), ethylene vinyl acetate (EVA), thermoplastic polyurethane (TPU), polycarbonate (PC), or high-density polyethylene (HDPE).

6. The protrusion-type impact absorbing member of claim 2, wherein the impact absorbing member is manufactured by injection-molding polypropylene (PP), polyethylene (PE), ethylene vinyl acetate (EVA), thermoplastic polyurethane (TPU), polycarbonate (PC), or high-density polyethylene (HDPE).

7. The protrusion-type impact absorbing member of claim 3, wherein the impact absorbing member is manufactured by injection-molding polypropylene (PP), polyethylene (PE), ethylene vinyl acetate (EVA), thermoplastic polyurethane (TPU), polycarbonate (PC), or high-density polyethylene (HDPE).

8. The protrusion-type impact absorbing member of claim 4, wherein the impact absorbing member is manufactured by injection-molding polypropylene (PP), polyethylene (PE), ethylene vinyl acetate (EVA), thermoplastic polyurethane (TPU), polycarbonate (PC), or high-density polyethylene (HDPE).
